(19) United States
(12) Patent Application Publication
(10) Pub. No.: US 2012/0285957 A1
(43) Pub. Date: Nov. 15, 2012

(54) MOLD FOR CUP LIDS, CUP LIDS MANUFACTURING METHOD USING THE SAME, AND CUP LID

(76) Inventor: Chi-Jui HUNG, Taichung City (TW)

(21) Appl. No.: 13/414,314

(22) Filed: Mar. 7, 2012

(30) Foreign Application Priority Data
May 13, 2011 (TW) 100208618

(51) Int. Cl. B65D 51/00; B29C 45/00; B29C 45/34

(52) U.S. Cl. 220/200; 425/546; 264/328.1

(57) ABSTRACT

The present invention provides a mold for cup lids including a male mold and a female mold, wherein the male mold has a convex member, an annular member, and a first air channel. The annular member is annularly disposed at outside of a periphery of the convex member, and a gap is formed between the convex member and the annular member. The first channel communicates the gap and an external space. When mold closing, a mold cavity is formed between the male and the female molds, and a second air channel communicating the mold cavity and the external space is also formed therebetween. The gap communicates with the mold cavity. Thereby, the mold of the present invention can be injected with plastic material, and original air inside can be discharged from the air channels. Hence, the yield rate of injection is improved.

### BACKGROUND OF THE INVENTION

1. Field of the Invention

The present invention relates to a cup lid, more especially to a mold for cup lids and cup lids manufacturing method using the mold.

2. Description of the Prior Art

To prevent drink from spilt from a disposable cup, a cup lid is usually used to cover the opening of the cup. Conventional cup lids set up a connection not tight enough with cups, so the cup lids are easy to drop off and drink inside are spilt.

To solve the problem, an improvement of cup lid is disclosed by the applicant of the present invention in TW M384844. However, if a jig is not used to fix the cup, the cup lid usually deforms the cup.

In addition, the yield rate of the cup lid mentioned above is low. Usually, cup lids are manufactured by plastic injection molding. The cup lid disclosed in TW M384844 has an extending clipper which is separated from the fringe of the cup lid, so that air in the mold usually stays around the extending clipper to unenable plastic material to be filled in entirely. Or, the product possibly has defects around the extending clipper to decrease the yield rate.

### SUMMARY OF THE INVENTION

The main object of the present invention is to improve the yield rate of manufacture of cup lids shaped by plastic injection.

Another object of the present invention is to improve the function of clipping of cup lids.

To achieve the above and other objects, a mold for cup lids includes a male mold and a female mold.

The male mold has a convex member, an annular member, and a first air channel. The annular element is annularly disposed outside of a periphery of the convex member. A gap is formed between the convex member and the annular member. The first air channel communicates the gap and an external space. The female mold has an annular groove. When mold closing, the convex member and the annular member are located in the annular groove, and a mold cavity is formed between the male and the female molds. A second air channel is formed and communicates the mold cavity and the external space. The mold cavity communicates with the gap and extends to the annular groove from a side of the annular member away from the convex member.

Thereby, the mold for cup lids of the present invention enables plastic material to be filled in the mold cavity and the gap rapidly after mold closing. Air in the mold cavity and the gap initially can be discharged via the first and the second air channels. Hence, the yield rate is improved. Besides, the product of cup lid has an inner clip portion and an outer clip portion, and a clip room is formed therebetween. Thus, the cup lid can clip on an opening of cup tightly to prevent fluid in cup from spilling.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown stereogram showing a mold for cup lids of the present invention;

FIG. 2 is a lateral cross-section view showing a mold for cup lids of the present invention;

FIG. 3 is a partial enlargement of FIG. 2;

FIG. 4 is a stereogram showing a cup lid of the present invention;

FIG. 5 is a lateral cross-section view showing a cup lid of the present invention;

FIG. 6 is a partial enlargement of FIG. 5.

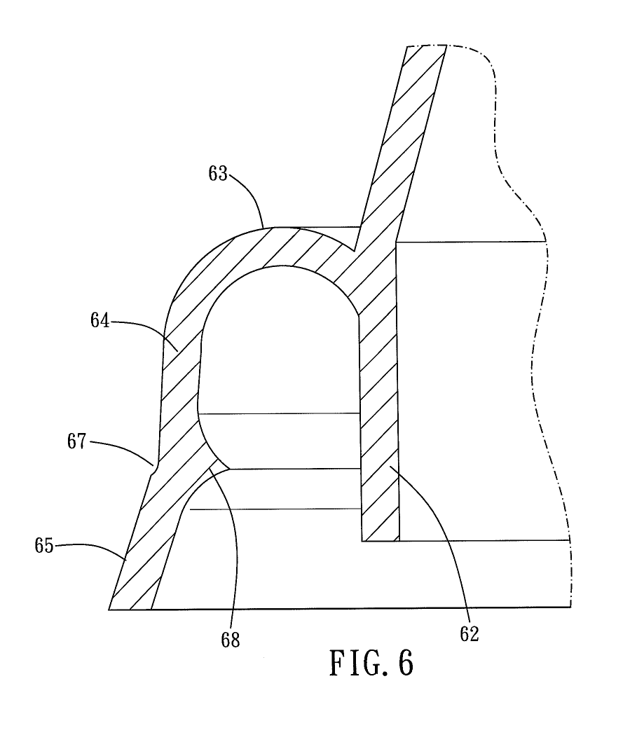

### DETAILED DESCRIPTION OF THE PREFERRED EMBODIMENTS

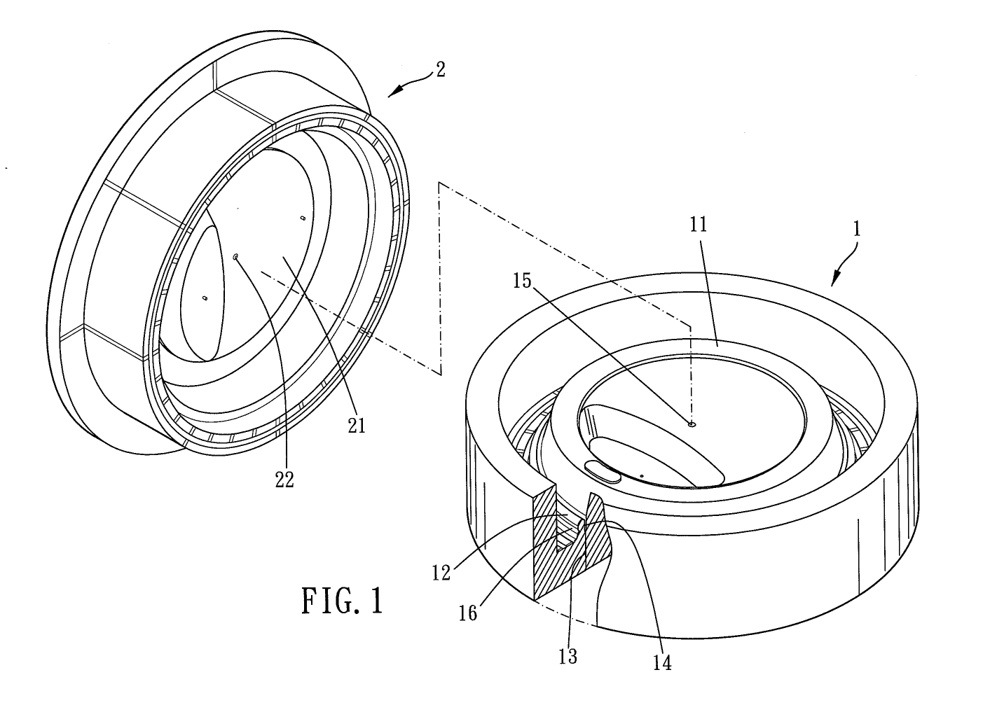

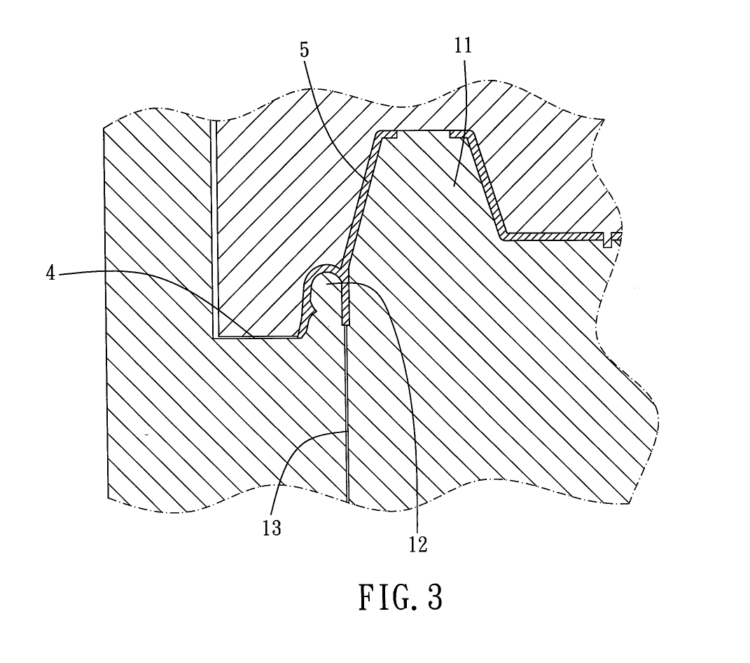

Please refer to FIG. 1 to FIG. 3, the mold for cup lids of the present invention includes a convex male mold 1 and a concave female mold 2. The male mold 1 has a convex member 11, an annular member 12, and a first air channel 13. The annular member 12 is annularly formed outside of a periphery of the convex member 11, and a gap 14 is formed between the convex member 11 and the annular member 12. The first air channel 13 communicates the gap 13 and an external space.

The female mold 2 has an annular groove 21. A mold cavity 3 in a predeterminate shape is formed between the male and the female molds 1,2. The mold cavity 3 communicates with the gap 14 and extends to the groove 21 from a side of the annular member 12 away from the convex member 11.

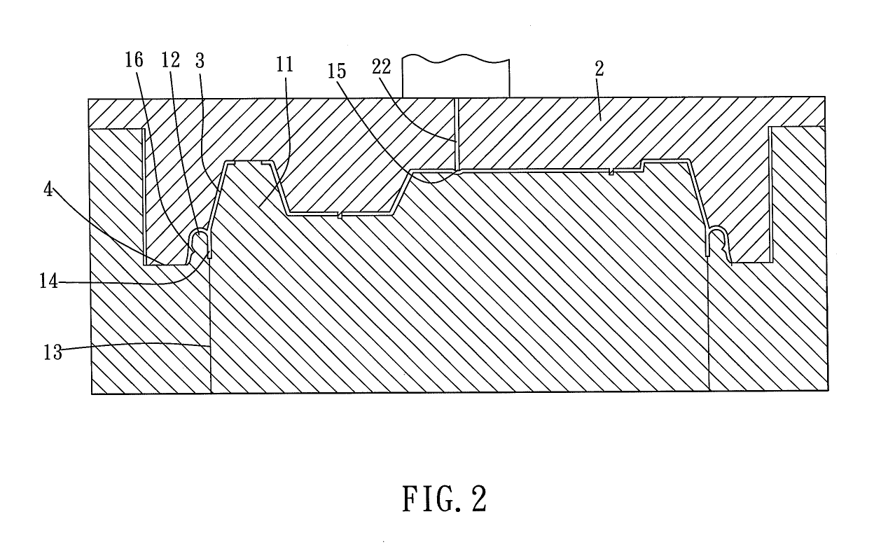

More specifically, the shape of the groove 21 corresponds to the shapes of the convex member 11 and the annular member 12. Thereby, the mold cavity 3 has shape of cup lid when the mold closed, as shown in FIG. 2. Besides, the mold cavity 3 and the gap 14 have widths both ranged from 0.3 mm to 0.5 mm. In other words, when plastic material injected into the mold cavity 3 and the gap 14 is cooled down and shrunken, the cup lid shaped has a width ranged from 0.3 mm to 0.4 mm. To acquire sufficient structure strength to clip cup openings in different thickness, plastic material in just a proper quantity is used during injection molding. Furthermore, the first air channel 13 has a width of 0.1 mm preferably. Thus, plastic material 5 flows into the first air channel 13 rarely after filling up the gap 14. Rough fringe of products shaped is avoided.

In the major embodiment of the present invention, the female mold 2 forms an injecting hole 22 communicating the mold cavity 3 and the external space. The male mold 1 forms a recess 15 at a position corresponding to the injecting hole 22. More preferably, the injecting hole 22 is located at a center of the mold cavity 3. Thereby, liquid plastic material can be injected into the recess 15 via the injecting hole 22 and then spreads in the whole mold cavity 3. More specifically, the plastic material initially entering the injecting hole 22 stays in the recess 15 to prevent from early solidification, wherein early solidification of plastic material obstructs flow of other plastic material. In another possible embodiment of the present invention, the injecting hole can be formed on the male mold, and the recess is formed on the female mold.

Please refer to FIG. 1 to FIG. 3. A cup lid which is able to clip to a cup opening can be obtained via the mold mentioned above according to steps below. First, a mold including a male mold 1 and a female mold 2 mentioned above is prepared. After the male and the female molds 1,2 are closed, plastic material 5 is injected into the mold cavity 3 via the injecting hole 22. The gap 14 and the mold cavity 3 are filled with plastic material 5. Air in the gap 14 and the mold cavity 3 initially is discharged via the first and the second air channels 13,4. And then, when the plastic material is cooled down, the mold is opened. The shaped plastic is separated from the mold. Hence, a cup lid is obtained. In detail, when the mold closing, the second air channel 4 is formed at the fringe of the mold cavity 3 to enable the plastic material flowing into the mold cavity 3 to discharge the air in the mold cavity 3 initially via the second air channel 4. Furthermore, because the gap 14 communicates with the mold cavity 3, plastic material also flows into the gap 14 during injection. And then, air in the gap 14 is pushed to the first air channel 13 and is discharged. Thereby, the mold cavity 3 and the gap 14 are filled with plastic material rapidly, so the influence by air in the mold cavity 3 and the gap 14 is reduced. The yield rate is thereby improved.

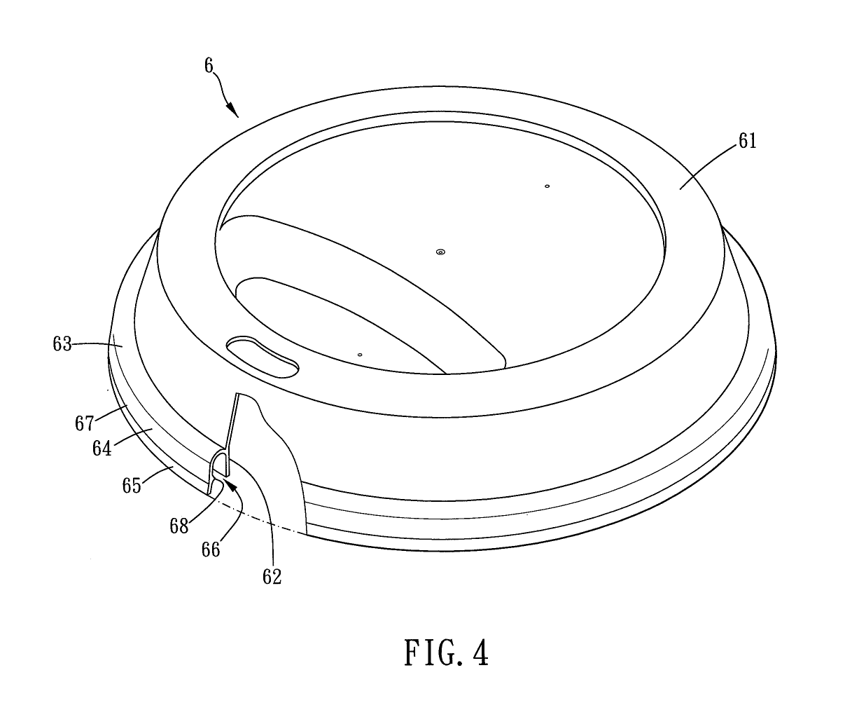

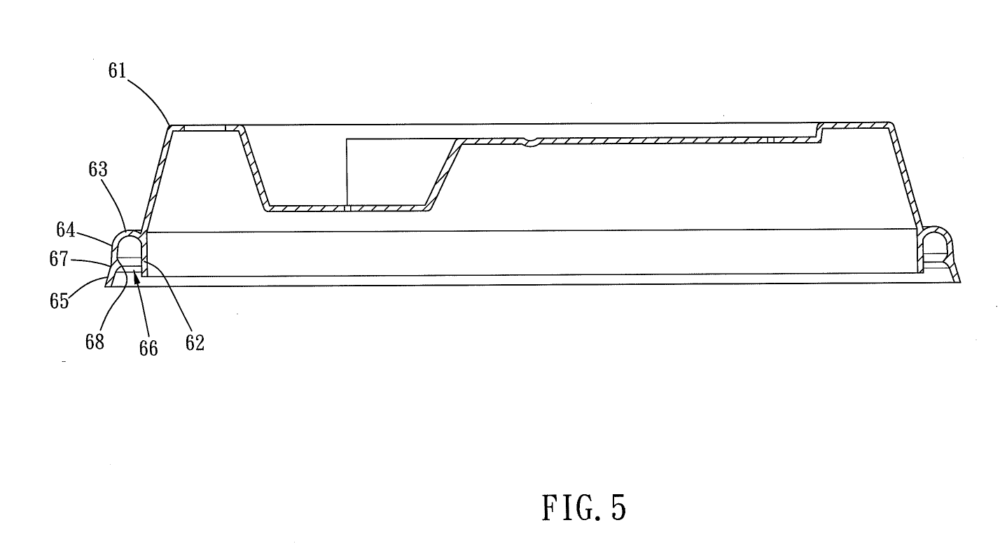

Referring to FIG. 4 and FIG. 5, the cup lid 6 of the present invention is obtained by the mold and the method mentioned above. The cup lid 6 has a shape corresponding to the mold cavity 3 and the gap 14. The cup lid 6 includes a body 61 and a clip portion. More specifically, the clip portion is annularly disposed under a fringe of the body 61 and includes an inner clip portion 62, a linking portion 63, an outer clip portion 64, and a guiding portion 65.

The inner clip portion 62, the linking portion 63, the outer clip portion 64 and the guiding portion 65 are all annular. The inner clip portion 62 extends from an underneath of fringe of the body 61 downward and longitudinally, so the inner clip portion 62 has an annularly tabular shape. The linking portion 63 is disposed between a top of the inner clip portion 62 and a top of the outer clip portion 64, so the outer clip portion 64 is arranged outside of the inner clip portion 62 in at an internal. The outer clip portion 64 extends longitudinally downward, and the linking portion 63, the inner clip portion 62, and the outer clip portion 64 become reversed U-shaped and enclose an annular clip room 66 which opens downward. The inner clip portion 62 is formed by a gap between the annular member and the convex member of the mold. An inner surface of the clip room 66 is formed by an outer surface of the annular member. The cup lid 6 has a width ranged from 0.2 mm to 0.4 mm to provide the inner clip portion 62 with appropriate flexibility and allowance. Thus, the clip portion 66 can be expanded to fit a cup more tightly.

The guiding portion 65 extends from a bottom of the outer clip portion 64 outward obliquely, so a bottom of the guiding portion has a fringe slightly larger than the outer clip portion 64. Hence, the guiding portion 65 can be used to match the opening of cup and to guide the opening of cup into the clip room 66. Besides, a furrow 67 is formed at a side away from the clip room 66 between the outer clip portion 64 and the guiding portion 65. Due to the furrow 67, an flexibility of a connection between the outer clip portion 64 and the guiding portion 65 is increased, so the outer clip portion 64 can be slightly pushed outward to expand the opening of the clip room 66 to enable the fringe of cup opening to enter the clip room 66.

In the major embodiment of the present invention, a protrude fringe 68 protrudes from the outer clip portion 64 toward the clip room 64. The protrude fringe 68 extends annularly along an inner side of the outer clip portion 64, and the position of the protrude fringe 68 corresponds to the position of the furrow 67. More preferably, the inner clip portion 62 extends downward beyond a horizontal plane the protrude fringe 68 being located. In other words, the distance between a bottom of the inner clip portion 62 and the linking portion 63 is larger than the distance between the protrude fringe 68 and the linking portion 63. Thereby, the protrude fringe 68 expands outward simultaneously with the furrow 67, so the cup opening can enter the clip room 66. After the cup opening enters the clip room 66, the furrow 67 and the protrude fringe 68 are repositioned, so the protrude fringe 68 can prop against an underneath fringe of cup opening.

To sum up, the mold for cup lid of the present invention is provided to be injected with plastic material. Air in the mold cavity can be discharged via the first and the second air channels. Thus, the mold cavity and the gap can be filled with plastic material rapidly and evenly. The cup lid with an inner clip portion can be thereby manufactured efficiently. Blemishes at the inner clip portion are avoided.

On the other hand, the clip portion has an appropriate thickness to provide a flexibility of the clip portion. Also, the clip portion has enough strength of structure to prevent the cup lid from disengaged from cup opening when squeezed by external force.

1. A mold for cup lids, including:
a male mold, including a convex member, an annular member, and a first air channel, the annular member being annularly disposed outside of a periphery of the convex member, a gap being formed between the convex member and the annular member, the first air channel communicating the gap and an external space;
a female mold, including an indentation;
wherein the annular member is located in the indentation when the male and the female molds are linked, a mold cavity with a predeterminate shape and a second air channel communicating the mold cavity and the external space are formed between the male and the female molds, the mold cavity communicates with the gap and extends from an end away from the convex member of the annular member to the indentation.

2. The mold for cup lids of claim 1, wherein one of the male or the female molds has an injecting hole, the injecting hole communicates the mold cavity and the external space, the other one of the male or the female molds has a recess which is one a location corresponding to the injecting hole.

3. The mold for cup lids of claim 1, wherein the end away from the convex member of the annular member forms an annular groove which communicates with the mold cavity.

4. The mold for cup lids of claim 2, wherein the end away from the convex member of the annular member forms an annular groove which communicates with the mold cavity.

5. The mold for cup lids of claim 1, wherein the mold cavity and the gap have widths ranged from 0.3 mm to 0.5 mm.

6. The mold for cup lids of claim 1, wherein the first air channel has a width of 0.1 mm.

7. A cup lids manufacturing method, including steps such as:
preparing a mold for cup lids of claim 1;
mold closing, injecting plastic material into the mold cavity, filling the gap and the mold cavity with plastic material, original air in the gap and the mold cavity is discharged via the first and the second air channels;
mold opening after plastic material is cooled down, separating the molded plastic material from the mold.

8-11. (canceled)
